(19) United States
(12) Patent Application Publication
(10) Pub. No.: US 2008/0218532 A1
(43) Pub. Date: Sep. 11, 2008

(54) CANVAS-LIKE AUTHORING EXPERIENCE ATOP A LAYOUT ENGINE

(75) Inventor: Kenneth L. Young, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/683,939

(22) Filed: Mar. 8, 2007

(51) Int. Cl. G09G 5/36

(52) U.S. Cl. 345/660; 345/619

(57) ABSTRACT

An apparatus and method provide for modifying a graphical layout intelligently. Objects may be placed in a grid structure which may include any number of rows and columns. In additional display elements such as icons or other adornments may be displayed corresponding to design functionality. The layout may function in any number of modes where each mode may provide different functionality. For example, in one mode, objects in a grid may be resized based on corresponding resizing of the grid. Also, the additional display elements may be displayed for control of the grid. In another mode, objects in a grid may be resized independently from resizing of the grid. Also, the additional display elements may be hidden from view.

### BACKGROUND

When designing the layout of user interface elements (window regions, controls, etc.), a designer canvas is often used and elements (also referred to herein as objects) are dropped onto the canvas. However, as the application is built and the area covered by the canvas is resized, it becomes difficult to get all the elements or objects to resize in an intelligent manner. Current approaches tend to be incomplete, complex, or opaque to the designer.

In addition, a user interface for designing a layout of user interface elements is often complex and confusing to a designer. Such a user interface often displays an overabundance of display elements which a designer may not understand. However, when the display elements are not provided, the designer may be more greatly confused due to a lack of an indication of available of controls to the designer.

Thus, there is a need for a system or method in which modification of user interface elements in a layout may be achieved simply and effectively while also providing a user-friendly control interface for the designer.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one example, a method or algorithm is provided for layout of objects in a grid structure. In this example, a grid is defined for placement of objects. Desired objects are placed in the grid. Also, layout of the objects may be performed in any number of modes. In one example, objects may be modified based on modifying the underlying grid in one mode while objects and the underlying grid may be modified independently in another mode.

In another example, display elements corresponding to layout or design functions may be displayed in one mode while the display elements may be hidden from view in another mode.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an example of a suitable computing system environment for graphical layout operations.

FIG. 2 illustrates one example of a layout of objects in a grid.

FIG. 3 is a high level flow diagram of one example of generating a grid.

FIG. 4 illustrates an example of a system for providing objects in a grid or canvas.

FIG. 5 illustrates an example of a grid for layout of objects.

FIG. 6 illustrates an example of a grid containing objects.

FIG. 7 illustrates another example of a grid containing objects.

FIG. 8 shows an example of a method of creating a grid canvas layout.

FIG. 9 illustrates an example of a design interface in a first mode.

FIG. 10 illustrates an example of an interface for a grid structure and corresponding functionality.

FIG. 11 illustrates another example of an interface for a grid structure.

FIG. 12 illustrates an example of modifying the size of the rows and/or columns of the grid during design time while in grid mode.

FIG. 13 illustrates another example of an interface during design time while in grid mode.

FIG. 14 illustrates one example of a system and user interface during design time while in canvas mode.

FIG. 15 illustrates an example of resizing a grid to a resized grid.

FIG. 16 is a flowchart illustrating an example of operating in different modes in a graphical user interface.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Systems described herein are provided as examples and not limitations. As those skilled in the art will appreciate, the present examples are suitable for application in a variety of different types of computing systems.

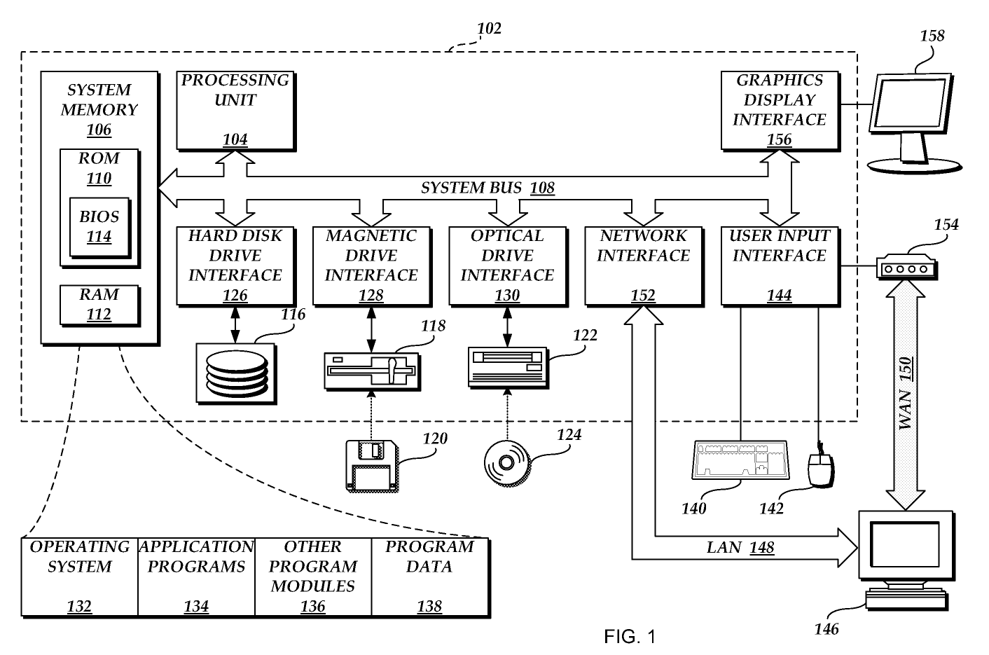

FIG. 1 illustrates an example of a suitable computing system environment or architecture in which computing subsystems may provide processing functionality. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The method or system disclosed herein is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The method or system may be described in the general context of computer-executable instructions, such as program modules, being executed by a computer. Generally, program modules include routines, programs, objects, components, data structures, etc. that perform particular tasks or implement particular abstract data types. The method or system may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the method or system includes a general purpose computing device in the form of a computer 102. Components of computer 102 may include, but are not limited to, a processing unit 104, a system memory 106, and a system bus 108 that couples various system components including the system memory to the processing unit 104. The system bus 108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 102 typically includes a variety of computer readable media. Computer readable media can be any available media that can be accessed by computer 102 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 102. Combinations of the any of the above should also be included within the scope of computer readable storage media.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 102, such as during start-up, is typically stored in ROM 110. RAM 112 typically contains data and/or program modules that are immediately accessible to and/or presently being operated on by processing unit 104. By way of example, and not limitation, FIG. 1 illustrates operating system 132, application programs 134, other program modules 136, and program data 138.

The computer 102 may also include other removable/non-removable, volatile/nonvolatile computer storage media. By way of example only, FIG. 1 illustrates a hard disk drive 116 that reads from or writes to non-removable, nonvolatile magnetic media, a magnetic disk drive 118 that reads from or writes to a removable, nonvolatile magnetic disk 120, and an optical disk drive 122 that reads from or writes to a removable, nonvolatile optical disk 124 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 116 is typically connected to the system bus 108 through a non-removable memory interface such as interface 126, and magnetic disk drive 118 and optical disk drive 122 are typically connected to the system bus 108 by a removable memory interface, such as interface 128 or 130.

The drives and their associated computer storage media discussed above and illustrated in FIG. 1, provide storage of computer readable instructions, data structures, program modules and other data for the computer 102. In FIG. 1, for example, hard disk drive 116 is illustrated as storing operating system 132, application programs 134, other program modules 136, and program data 138. Note that these components can either be the same as or different from additional operating systems, application programs, other program modules, and program data, for example, different copies of any of the elements. A user may enter commands and information into the computer 102 through input devices such as a keyboard 140 and pointing device 142, commonly referred to as a mouse, trackball or touch pad. Other input devices (not shown) may include a microphone, joystick, game pad, pen, scanner, or the like. These and other input devices are often connected to the processing unit 104 through a user input interface 144 that is coupled to the system bus, but may be connected by other interface and bus structures, such as a parallel port, game port or a universal serial bus (USB). A monitor 158 or other type of display device is also connected to the system bus 108 via an interface, such as a video interface or graphics display interface 156. In addition to the monitor 158, computers may also include other peripheral output devices such as speakers (not shown) and printer (not shown), which may be connected through an output peripheral interface (not shown).

The computer 102 may operate in a networked environment using logical connections to one or more remote computers, such as a remote computer. The remote computer may be a personal computer, a server, a router, a network PC, a peer device or other common network node, and typically includes many or all of the elements described above relative to the computer 102. The logical connections depicted in FIG. 1 include a local area network (LAN) 148 and a wide area network (WAN) 150, but may also include other networks. Such networking environments are commonplace in offices, enterprise-wide computer networks, intranets and the Internet.

When used in a LAN networking environment, the computer 102 is connected to the LAN 148 through a network interface or adapter 152. When used in a WAN networking environment, the computer 102 typically includes a modem 154 or other means for establishing communications over the WAN 150, such as the Internet. The modem 154, which may be internal or external, may be connected to the system bus 108 via the user input interface 144, or other appropriate mechanism. In a networked environment, program modules depicted relative to the computer 102, or portions thereof, may be stored in the remote memory storage device. By way of example, and not limitation, remote application programs may reside on a memory device. It will be appreciated that the network connections shown are exemplary and other means of establishing a communications link between the computers may be used.

A method and system is described for placement, management, and manipulation of objects or elements in a layout. The objects may exist at design time during which time a user or designer may create a layout of objects in a document or may exist at runtime during which time an application may execute to create the document containing the layout of objects as specified by the designer during design time. Behavior of the objects during each of runtime and design time may be different.

In addition, the objects in the workspace and corresponding behaviors may be provided in any number of different modes during each of design time or runtime. For example, the layout may be provided in a grid mode in which an underlying grid structure is provided in which objects may be placed or manipulated. In this example, the layout may include a grid containing any number of rows and columns. In one example, the grid corresponds to a workspace area in which objects are arranged and placed. The grid or workspace may further be modified. For example, a size of a dimension of the grid or workspace may be altered. In additional any number or type of adornments or display elements may be provided corresponding to functionality of the grid or workspace.

The layout may also operate in a different mode from the grid mode. In another mode, e.g., canvas mode, different behavior of the grid or objects within the grid or different display elements may be achieved. For example, in one mode, modification of the size of a dimension of the grid may result in a particular type of behavior of objects placed within the grid while in another mode, the behavior may be changed. The different behaviors based on mode of operation are described in further detail below.

In another example, in one mode (e.g., grid mode), the user interface containing the grid or workspace may include any number or type of adornments or other display elements corresponding to formatting, functionality, or other relevant characteristics pertaining to management of grid and/or objects within the grid. Such display elements may not be visible on the display in another mode of operation (e.g., canvas mode). In another example, the display elements are not visible on the display in the other mode of operation (e.g., canvas mode), however, the functionality of the display elements are still present such that modification of the grid or objects within the grid comport with the functions corresponding to the non-visible display elements. Such display elements and corresponding functionality are described in more detail below.

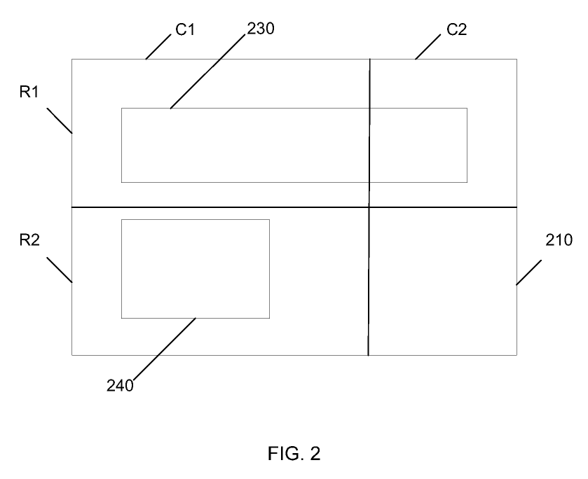

The rows and columns of the grid may form any number of cells in which objects may be placed. Any of the objects positioned in the grid may occupy any number of cells. FIG. 2 illustrates one example of a layout of objects in a grid. In this example, a parent 210 is displayed on a canvas on which objects 30, 40 may be drawn in any location. The grid 210 may be split into as many rows R and columns C as desired. In the example illustrated in FIG. 2, the grid 210 contains two rows (R1, R2) and two columns (C1, C2). Thus, four cells are formed by the intersection of the rows and columns.

Child elements (i.e., objects) are also illustrated in the example of FIG. 2. In this example, the child elements or objects include object 230 and object 240. Each cell formed by the intersection of the rows and columns includes a grid bounding box a particular distance or margin from an object. For example, the grid bounding box for object 230 includes row R1 (i.e., the combination of the cell formed by the intersection of row R1 and column C1 and the cell formed by the intersection of row R1 and column C2). In addition, margin settings may provide an offset between an aspect of a grid bounding box and a corresponding aspect of a child element or object within the grid bounding box. Also, any of the rows or columns may be sized or resized on the grid 210. For example, the sizes of any of the rows or columns may be fixed, may be specified as a percentage, may be auto-sized, or may be a weighted size, to name a few.

The intersection of rows and columns form a coordinate system in a virtual grid. The coordinates in the grid may represent positions of objects within each of the cells. Also, any object in a grid may occupy any number of cells in the grid. For example, an object may span multiple adjacent cells in a grid. In the example illustrated in FIG. 2, object 230 occupies at least a portion of two adjacent cells in the underlying grid 210. In one example, the one cell may be modified in conjunction or in tandem with resizing of another cell. In another example, each cell may be modified individually or independently.

Objects may be modified via modification of the cells in which the objects reside. Hence, an object's layout behavior may be determined by settings for the cells containing the object. For example, a cell may be assigned a fixed size by specifying a fixed pixel width value (column width) and a fixed pixel height value (column height). Alternatively, a dimension of a row or column may be calculated or adjusted in a variety of ways. For example, a width of a column may be determined based on a desired width of objects within the column, a height of a row may be determined based on a proportion of remaining available space, etc. These are merely examples as any suitable method of determining a size of a dimension of a column, row, or cell of a grid may be used.

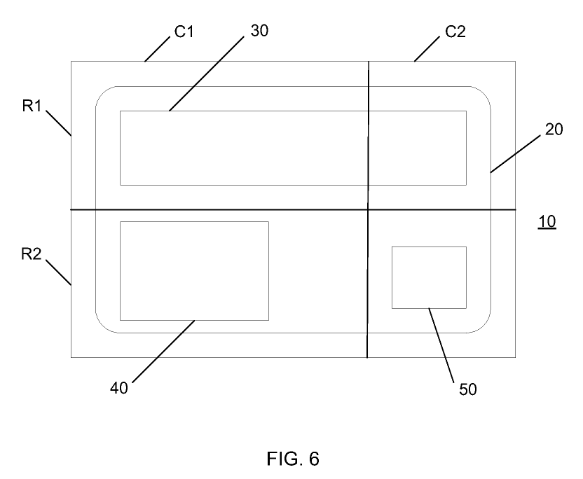

Also, objects within any of the cells of a grid may overlap. For example, any number of objects or portions thereof may occupy the same cell or subset of cells (e.g., objects 20 and 30 in FIG. 6). In this example, modification of a dimension of the grid may cause a corresponding modification of an aspect of overlapping objects within a cell of the grid.

An object in the grid may have properties such as, but not limited to, grid coordinates of a bounding box of cells, margins of the bounding box, height of the object, width of the object, etc. Any of the parameters may be designated “auto” such that the “auto” dimensions take up as much space as is available to maintain appropriate ratios and positions. In this example, multiple objects may contribute to a particular dimension of multiple cells in the grid. If one object has an “auto” dimension, modification of the dimension of the grid may result in the “auto” dimension object being correspondingly modified while the other objects in which the dimension is not set to “auto” may remain substantially constant.

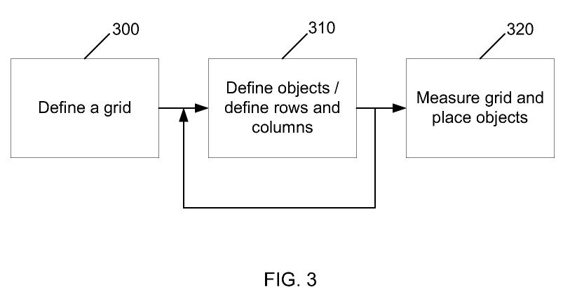

FIG. 3 is a high level flow diagram of one example of generating a grid. In STEP 300, the grid is created by specifying a grid of row and columns. The rows and columns may be specified, for example, by specifying corresponding grid lines. In STEP 310, objects, rows, and/or columns are defined based on various properties and/or attributes. Each object may be defined in this manner. This may include determining dimension sizes of each object, placement or location of each object, location of corresponding cells for each object, etc. The grid may then be measured and objects may be placed within the grid (STEP 320). In one example, any number of objects may be placed on a canvas and the grid may be configured after placement of the objects on the canvas. In another example, rows and/or columns may be placed in the grid after the objects are placed. For example, objects may be placed in a workspace without an underlying coordinate system or grid. Subsequent to placing the objects in the workspace, a grid or coordinate system of rows and columns may be placed.

Rows or columns may be modified such that a size of any dimension of any of the rows or columns may be adjusted. Alternatively, any of the rows or columns or portion thereof may be fixed in size (i.e., the size may be set at a value that is not changed). Objects may be defined based on characteristics of the rows or columns of the grid. For example, a row, column, combination of multiple rows and/or columns, may be specified as a bounding box of any object. Any number of parameters may be specified for an object. For example, a specification of the object may also include a width of the object, height of the object, or margin (e.g., left margin, right margin, bottom margin, or top margin) of the object. Based on the indicated rows or columns or any other relevant parameter, the object(s) may be placed within the grid.

As described above in this example, an object may be arranged within a grid based on the rows, columns and gridlines of the grid. Any of the rows or columns of the grid may be specified in terms of size or proportion of dimensions. This may include, for example, a fixed size of a particular dimension of one or more rows or columns, a percentage value corresponding to a size of a dimension, a minimum or maximum size of a dimension, etc. In this example, modification of a size of a cell in the grid may result in a corresponding modification of a corresponding aspect of an object contained within the modified cell. For example, if an object is located within a cell and the width of the cell is increased or decreased, the width of the object contained within the cell may also increase or decrease proportionately.

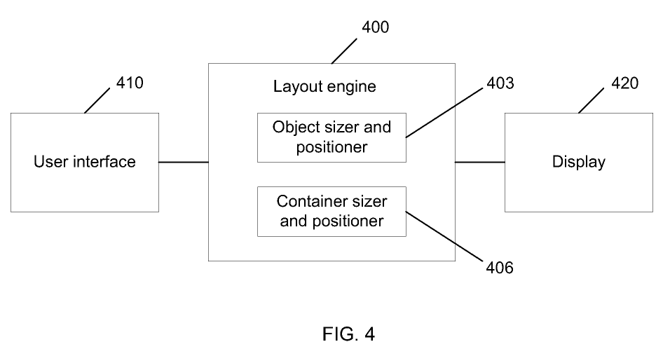

FIG. 4 illustrates an example of a system for providing objects in a container such as a grid or canvas. In this example, an algorithm may provide a process for determining sizes of rows of a cell or a grid, columns of a cell or the grid, or objects placed within the grid or within any cells or combination of cells of the container (e.g., grid or canvas). Also, positions or locations within the grid of the objects may be determined. In this example, a layout engine 400 communicates with a user interface 410 and a display 420. The layout engine 400 may include routines 403, 406 for determining a size or position/location of an object and/or a size or position of a container (e.g., grid or canvas), respectively.

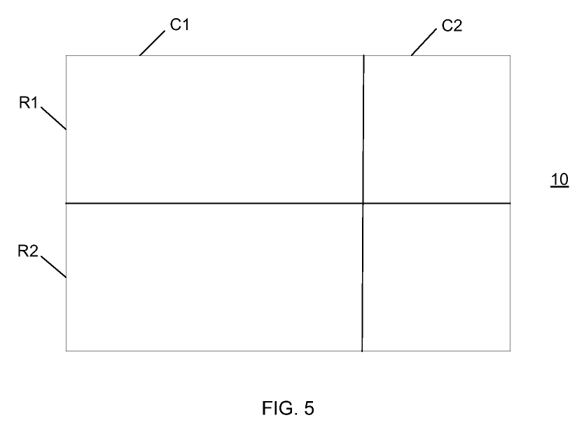

FIG. 5 illustrates an example of a grid for layout of objects in a workspace. In this example, a grid 10 is created containing two rows (R1, R2) and two columns (C1, C2). It is noted that FIG. 5 is merely an example and any number of rows or columns may be used. FIG. 6 illustrates the grid of FIG. 5 containing objects. Object 20 is positioned within four cells of the grid 10. As FIG. 6 illustrates, object 20 spans a first cell formed by R1 and C1, a second cell formed by R1 and C2, a third cell formed by R2 and C1, and a fourth cell formed by R2 and C2. Object 30 overlaps object 20 and spans the first and second cells. Object 40 also overlaps object 20 and is contained entirely within the third cell. Object 50 overlaps object 20 and is contained within the fourth cell. As FIG. 6 illustrates, objects may be placed anywhere in the grid 10, may cover any number of cells, and may overlap with other objects.

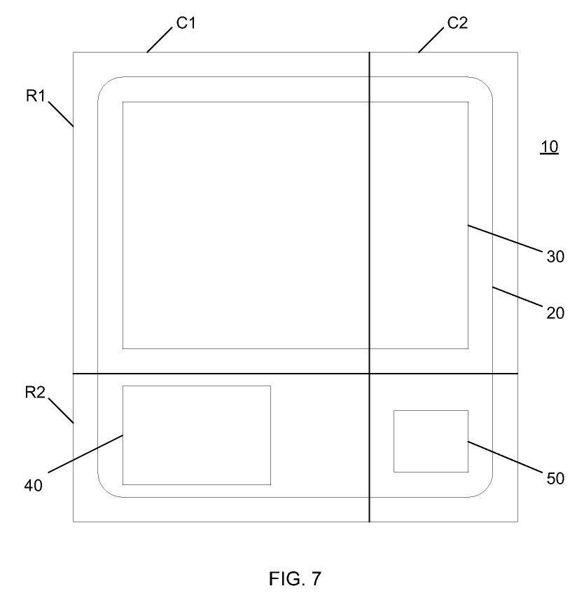

In one example, row R2 of the grid 10 in FIG. 6 is desired to have an absolute height whereas the top row R1 is desired to consume all remaining space. When this layout is resized taller, the desired result is shown in FIG. 7. Note that row R2, and the objects or portions of objects contained therein, remain at their original fixed heights. On the other hand, row R1, and the objects or portions of objects contained therein, have been resized vertically to cover the additional space in that direction. The relative proportions of objects and cells to each other remain substantially the same in row R1 as in the original unresized row R1.

In this example, the layout may be achieved by configuring the rows and columns accordingly and configuring object relationships to the grid, including margins. A coordinate system may be used in which each of the cells may be defined, a distance between an edge of an object and the corresponding edge of a cell may be determined as the margin and the margin may further defined. The object relations may then be defined for the objects (e.g., objects 20, 30, 40, and 50). In another example, alignment may be a distinct property. For example, an object may be aligned on one side (e.g., on the left side) with a resulting margin on an opposite side (e.g., right margin of 20). In this example, the object may remain at least 20 pixels from the right side after modifications to the object. Hence, if the size of the object or grid is altered, the right margin of the object (i.e., distance from the right side of the object to the corresponding aspect of the grid) is maintained at least 20 pixels.

Determination of the object relations for the objects in this example may be accomplished in a variety of ways. For example, Object 20: grid location=(0,0)-(1,1) (this means that the object spans cell (0,0) to cell (1,1), as shown); margin=(10,10,10,10) (this means that the distance from an edge in each direction to its corresponding grid cell edge is 10 pixels) (note that the drawings are not to scale); width=auto; height=auto. Object 30: grid location=(0,0)-(10); margin=(20,20,20,10); width=auto; height=auto. Object 40: grid location=(0,1)-(0,1); margin=(20,10,auto,20); width=fixed (e.g., 100); height=auto. Object 50: grid location=(1,1)-(11); margin=(10,10,10,auto); width=auto; height=fixed (e.g., 40).

Explicit values may denote explicit measurements, and auto values may consume the remaining available space. It is contemplated that in various implementations, the margins could be specified for all sides, and then additional attachment flags could be added. Moreover, values requested by the child may not be achievable by the parent, in which case the grid canvas may handle overconstrained problems by returning an error message, for example, or revising the value so that it is valid, for example.

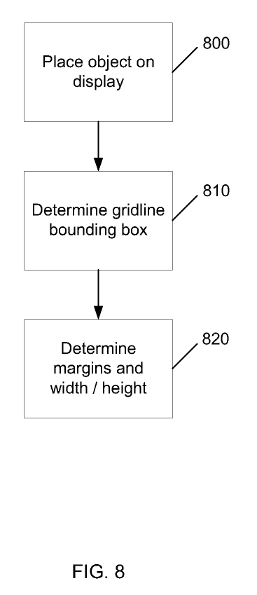

The grid or workplace may be generated during design time in a process in which a grid layout may be created using a minimum amount of user specification. The layout author or designer may be provided with the ability to define the layout shape and the layout dynamic behavior. FIG. 8 shows an example of a method of creating a grid canvas layout. At step 800, a designer places an object at a specific location on the display (e.g., in the user interface on the display). Its gridline bounding box is determined, at step 810. This maps to the grid location property described above. Then, by comparing the extents of this gridline bounding box with the desired position, appropriate margins and width/height can be determined, at step 820, e.g., according to a default scheme. An exemplary default scheme is one in which (1) if the specified location is entirely in the left half of the gridline box extents, an explicit left margin and width is set, and the right margin is set to auto; (2) if the specified location is entirely in the right half of the gridline box extents, an explicit right margin and width is set, and the left margin is set to auto; (3) if the specified location spans the centerline of the gridline box extents, an explicit left and right margin is set, and the width is set to auto; and (4) height and top/bottom margins are handled in an analogous manner.

The objects may exist at design time during which time a user or designer may create a layout of objects in a document or may exist at runtime during which time an application may execute to create the document containing the layout of objects as specified by the designer during design time. Behavior of the objects during each of runtime and design time may be different. In addition, the objects in the workspace and corresponding behaviors may be provided in any number of different modes during each of design time or runtime. A user or designer may toggle between different modes for a different design experience.

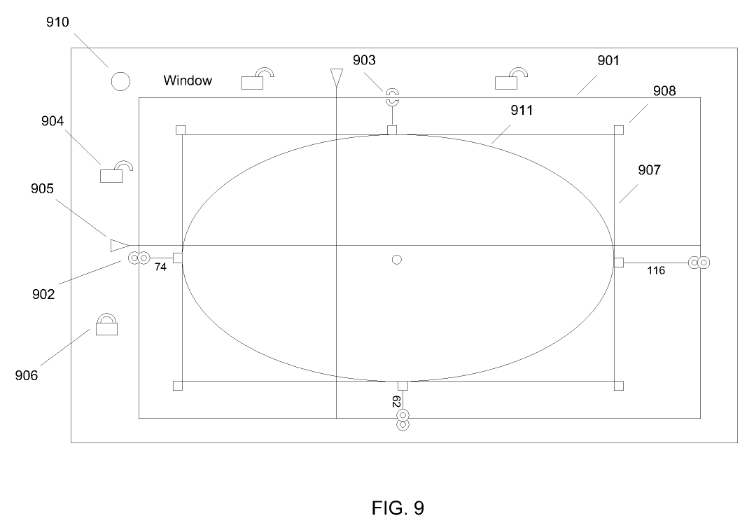

In one example, design may be performed in a first mode. FIG. 9 illustrates an example of a design interface in a first mode such as a grid mode that contains a grid for placing, locating or manipulating objects. For example, a selection may be received such as a selection of a grid icon 910. Responsive to the selection, the system may enter a grid mode. In grid mode, an underlying grid 901 may be provided and objects (e.g., object 911) may be placed within the grid 901. The grid 901 may further be displayed to a user or designer as illustrated in FIG. 9. Resizing of the grid 901 may result in a proportionate modification or resizing of the objects placed within the grid 901 such as object 911. Object 911 is illustrated in FIG. 9 with a bounding box 907. Additionally, icons, controls, and/or adornments corresponding to design functionality may be displayed in grid mode. For example, an aspect of an object 911 may be fixed (i.e., “locked”) with respect to a corresponding aspect in a grid bounding box of the object. A margin may be specified indicating a distance or proportion of space separating an aspect of an object 911 and a corresponding aspect of a bounding grid box. In this case, alteration of the grid bounding box 901 may result in a corresponding alteration of the object 911 such that movement or resizing of the grid bounding box 901 results in a corresponding fixed movement or proportional resizing of the object 911.

An icon or other display element may be displayed in grid mode corresponding to the lock function. For example, a first icon may be displayed indicating that a margin is determined for a distance between an aspect of an object and a corresponding aspect of a grid bounding box while a second icon may be provided or displayed for indicating that a margin has been removed or is not set. As the example illustrated in FIG. 9 shows, an icon such as icon 902 may be provided on the display for indicating that an aspect of a grid or object is “locked” to the corresponding aspect of the grid 901. Also, a second icon such as icon 903 may be displayed to indicate that an aspect of an object is not locked to the corresponding aspect of the grid 901. Margin distances may be displayed such as element 912 in FIG. 9.

Any additional icons, adornments, or display elements may be provided or displayed in grid mode. For example, anchor points or anchor axes may be provided such that modification of a grid bounding box around an anchor axis may result in modifications of objects or cells in the grid around the axis. FIG. 9 illustrates an example of an icon 905 indicating an anchor point or axis corresponding to the grid 901.

Also, an icon 904 may be displayed indicating a characteristic of a row or column. In this example, icon 904 is displayed as illustrated in the example of FIG. 9 to indicate that a size of a corresponding row is unlocked such that the size of the row may be modified as the corresponding size of the grid 901 is modified. In this example, the first row is unlocked as indicated by the icon 904. Thus, if the height of the grid 901 is decreased, the height of the first row may be decreased accordingly. Similarly, if the height of the grid 901 is increased, the height of the first row may also be increased accordingly.

Another icon such as icon 906 may also be displayed for indicating that a row or column is locked such that a dimension or size of the row or column is fixed at a particular size. For example, icon 906 indicates that the second row is locked so that the height of the second row may remain substantially constant when the grid 901 is modified in size. For example, if the grid 901 is decreased in height, the height of the second row may remain substantially the same. The decrease in height may thus be accommodated in this example by a corresponding decrease in height of the first row. Similarly, if the grid 901 is increased in height, the height of the second row may also remain substantially the same such that the height of the first row (which is not locked in this example) may increase in proportion to the increase in height of the grid 901.

The icon 905 in this example may be displayed indicating the presence, placement, or location of an anchor axis. The icon corresponding to the anchor axis may further be removed from the display such that a user or designer does not visualize the icon even though the anchor functionality is still active. Another icon or display element may be provided for toggling between states of visibility of the icon or display element corresponding to the anchor functionality. For example, a toggle type icon 910 may be provided such that selection of the toggle type icon results in appearance of the anchor functionality icon and disappearance of the anchor functionality icon.

Also, sizing of rows and/or columns in the grid may be indicated while in grid mode. An icon, adornment, or display element may be provided and displayed corresponding to sizing of the rows and/or columns. Also, the icon or other display element may indicate behavior of the sizing of the rows and/or columns of the grid. For example, a width of a column may be fixed such that adjustments or modifications of the grid do not result in alterations of the width of the fixed column. In this case, an icon or display element may be displayed for indicating that the width of the column is fixed or locked. A user or designer may also cause the system to toggle between different states such that the icon or display element indicating a size functionality of a row or column is displayed when desired but may also be removed from the display (i.e., not displayed) when desired.

The grid 901 may further include handles for management or modification. For example, any number of icons or display elements (e.g., icon 908) may be displayed such that a user or designer may move or otherwise modify the grid 901. For example, a user or designer may drag a handle such as icon 908 to alter the size and/or shape of the grid 901.

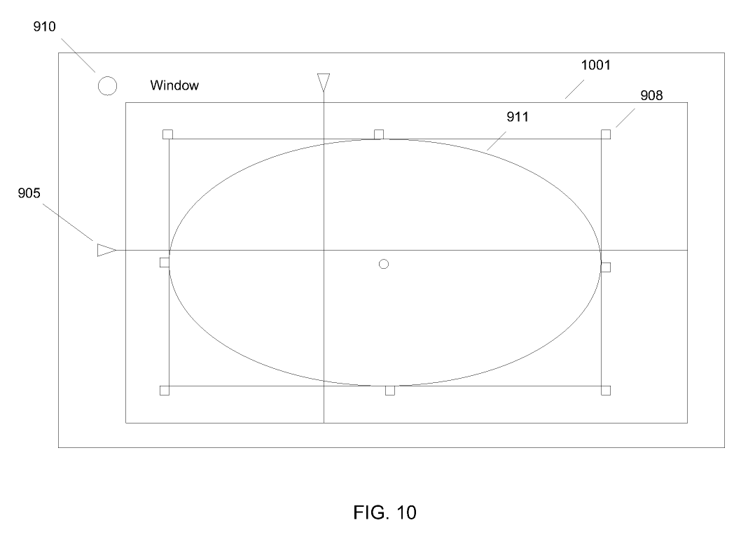

The display may be changed to an alternate mode for different behavior. For example, a user or designer may select the grid icon 910 to toggle between different states or modes. By switching to a different mode, different functionalities may be obtain. For example, a system may be in grid mode as described above and may further receive a selection via the grid icon 910. The selection of the grid icon 910 may cause the system and display to change to another mode such as canvas mode. In canvas mode, a different set of icons or display elements may be displayed as compared to the interface in grid mode. FIG. 10 illustrates an example of an interface for a grid structure 1001 and an object 911 and corresponding functionality in canvas mode. In this example, the interface may include a grid 1001. Other icons or display elements such as icons associated with locking of a size of a row or column, icons associated with anchoring a row or column or aspect of a row or column, or icons associated with margins of an object to a corresponding aspect of a grid may be invisible to the user or designer. Thus, FIG. 10 illustrates an example of an interface during design time in which a simplified set of icons or display elements are provided or displayed for a user or designer. In this example, the functionality of the grid as described above may be present, however, the icons or display elements corresponding to the functionality of the grid may not be displayed.

In another example, a subset of icons or display elements may be displayed in canvas mode during design time. FIG. 10 illustrates the display of handles of the grid 1001. The handles (e.g., handle 1004) may be displayed in association with the grid 1001 even if the grid 1001 is not visible on the display during design time. However, icons associated with locking of a size of a row or column, margin setting, and/or anchoring are not displayed in this example although the functions associated with any of the icons may still be available to the user or designer.

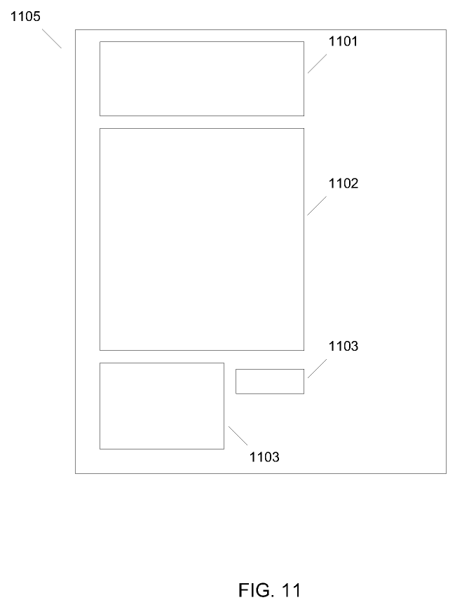

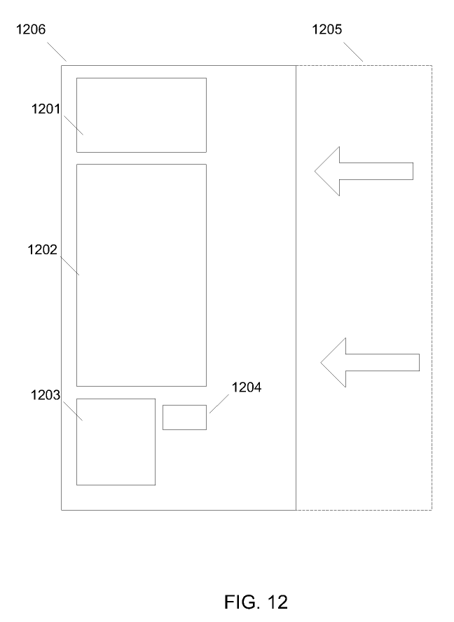

In addition, during design time, an interface may be provided in grid mode containing an underlying grid 1105 as illustrated in the example of FIG. 11. Objects, such as object 1101, 1102, 1103, 1104 may be positioned within the grid 1105. FIG. 12 illustrates an example of modifying the size of the rows and/or columns of the grid during design time while in grid mode. In this case, the width of the underlying grid 1205 decreases. The objects contained within grid 1205 (i.e., objects 1201, 1202, 1203, 1204, in this example) decrease in size accordingly as the size of the grid 1205 is decreased to the resized grid 1206 (indicated by the arrows). In this case, the objects 1201, 1202, 1203, and 1204 decrease in size proportional to the decrease in size (i.e., width in this example) of the underlying grid structure 1205.

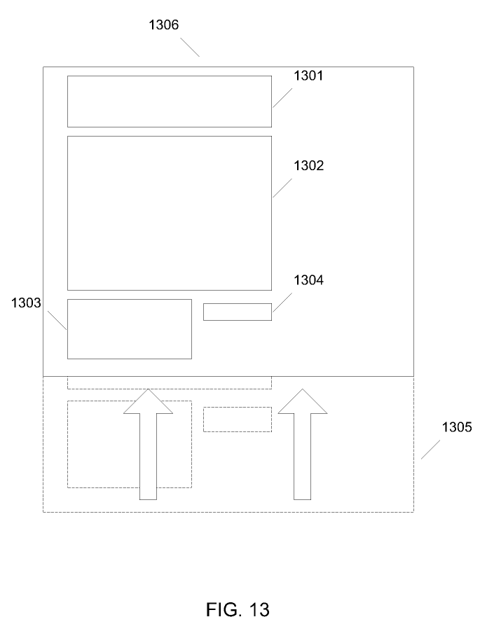

FIG. 13 illustrates another example of an interface during design time while in grid mode. In this example, the size of the height of the grid 1305 is decreased to a resized grid 1306. The objects contained within the grid 1305 (i.e., objects 1301, 1302, 1303, 1304) are also resized in proportion to the change in size (i.e., height in this example) of the grid 1305 to the resized size 1306. In another example, objects 1303 and 1304 may retain their original heights as the grid 1305 is decreased in height. In this case, object 1302 may be reduced in size accordingly to accommodate the decrease in height of the grid 1305.

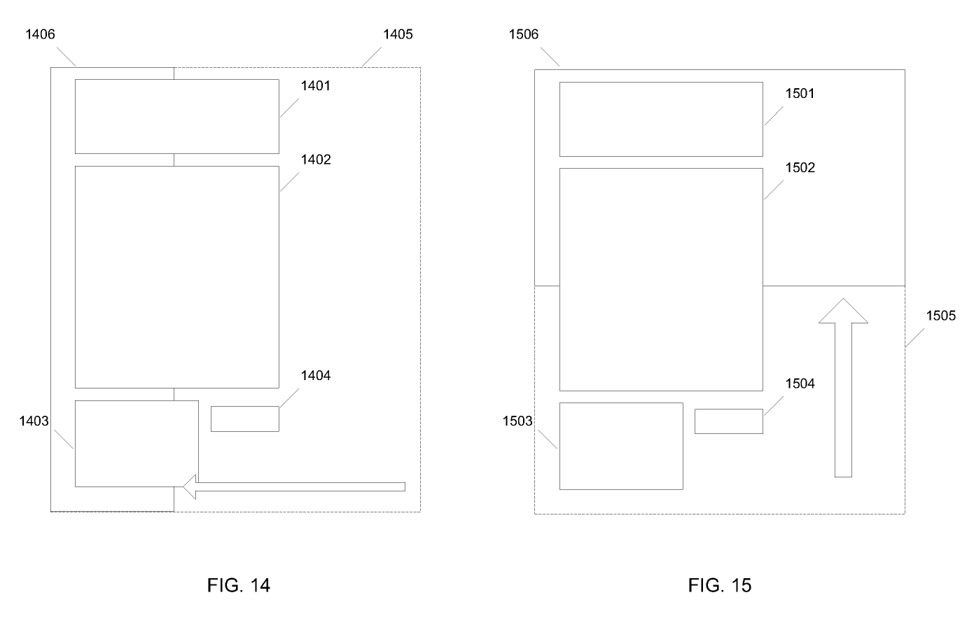

However, in another example, the system may be switched to an alternate (e.g., canvas) mode while in design time. In canvas mode during design time, the behavior may change such that any set or subset of icons may be simplified. In this example, any icons may be invisible to the user or designer by not displaying the icons on the display as described above. Also, a relationship of changes to characteristics of the grid to changes in corresponding changes to characteristics of objects within the grid may be different. FIG. 14 illustrates one example of a system and user interface during design time while in canvas mode. In this example, the width of the grid 1405 may be decreased, as shown in FIG. 14 to a resized grid 1406. In this case, the resized grid 1406 is narrower than the original grid 1405. Objects 1401, 1402, 1403, 1404 are contained within the original grid 1405. Decreasing the width of the original grid 1405 does not substantially impact the sizing of objects 1401, 1402, 1403, 1404. Rather, in this example of operating in canvas mode, resizing the grid 1405 is performed substantially independently of resizing of the objects (e.g., object 1401, 1402, 1403, 1404, in this example).

Similarly, FIG. 15 illustrates an example of resizing a grid 1505 to a resized grid 1506 during design time in which the height of grid 1505 is decreased to create resized grid 1506. Objects 1501, 1502, 1503, 1504 contained within grid 1505 remain substantially the same in size when grid 1505 is decreased in height to the resized grid 1506 (as indicated by the arrow). Hence, in this example, the size of objects 1501, 1502, 1503, 1504 within the grid 1505 are maintained independently of the sizes of corresponding aspects of the grid 1505. In this example, increasing or decreasing or otherwise modifying an aspect of the grid in design time may be performed without substantially impacting characteristics of the objects contained within the grid.

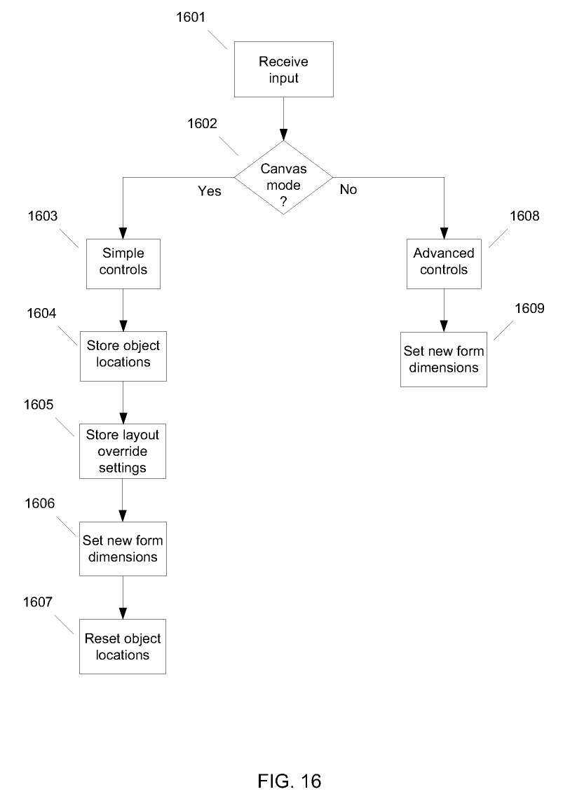

FIG. 16 is a flowchart illustrating an example of operating in different modes in a graphical user interface. In one example, the number and type of controls to display to a user or designer may be determined. Subsequently, behavior at design time may be determined based on a mode in which the interface is operating. For example, determination of which controls to display, if any, may be made in STEPS 1603 and 1608 to be described more fully below. Also, the determination of behavior at design time may be made during steps 1604, 1605, 1606, 1067, and 1609, to be described more fully below. In this example, an input may be received (STEP 1601), for example, from a user or designer. A designer may select an icon or other display element to control a mode of operation of the system. For example, a grid icon may be provided such that a user or designer may select the grid icon to toggle between different modes. If a grid mode is selected (“No” branch of STEP 1602), objects may be placed within a grid displayed on the interface. The objects may be placed in any number of cells that are formed by rows and columns of the grid. Margins may also be defined indicating a size or distance between an aspect of an object and a corresponding aspect of the grid. Modifications of the grid may cause a corresponding modification to objects within the cells of the grid.

In addition, controls, icons, or other display elements may be displayed while in grid mode (STEP 1608). The display elements may indicate functionality of the grid structure. For example, the display elements may include icons or controls for setting margins, determining or defining a status of a grid cell or bounding grid box in relation to an object, size or behavior of a row or column of a grid, etc. Modification of the grid may result in setting new form dimensions (STEP 1609) and modification of objects within the grid accordingly as described.

Based on the input received (STEP 1601), the system or interface may enter canvas mode (“Yes” branch of STEP 1602). For example, a user or designer may select a control for toggling between modes such that the system or interface may switch from a grid mode to a canvas mode. In canvas mode during design time, controls or icons corresponding to functions of the grid may be hidden. Hence, in this example, the controls, icons or other display elements may be invisible to the user or designer during design time or run time. In this case, the display may not contain the icons or controls such that the display may provide an uncluttered appearance.

Alternatively or additionally, a subset of icons or display elements (e.g., simple controls) may be provided on a display while in canvas mode (STEP 1603). In this example, any desired subset of display elements selected from a set of display elements displayed during grid mode may be selected for display in canvas mode and unselected display elements may not be displayed in canvas mode and may remain invisible to or hidden from the user or designer while in canvas mode. In another example, a user or designer may select a control in canvas mode to display the set of display elements available or displayed in grid mode while in canvas mode, if desired.

Objects may be placed in the grid and the location of the placed objects may be recorded or stored (STEP 1604). In addition, the layout of the objects within the grid may also be stored (STEP 1605) including settings corresponding to the layout. In one example, the grid or workspace may be resized or otherwise modified. For example, new form dimensions may be set (STEP 1606) such that a workspace or grid may be resized relative to the objects placed within the workspace or grid. Responsive to resizing of the workspace or grid, the locations of the objects within the workspace or grid are reset relative to the resized workspace or grid (STEP 1607). In one example in canvas mode, the user or designer may perceive a resizing of the workspace or grid but perceives no substantial movement or modification of the objects placed in the grid or workspace at design time (see FIGS. 14 and 15, for exam pie).

It is understood that aspects of the present description can take many forms and embodiments. The embodiments shown herein are intended to illustrate rather than to limit the description, it being appreciated that variations may be made without departing from the spirit of the scope of the invention. Although illustrative embodiments have been shown and described, a wide range of modification, change and substitution is intended in the foregoing disclosure and in some instances some features may be employed without a corresponding use of the other features. Accordingly, it is appropriate that the appended claims be construed broadly and in a manner consistent with the scope of the invention.

1. A method of designing a graphical display element comprising:
defining a grid;
positioning an object on the grid;
displaying a first display element for changing operation between at least a first mode and a second mode,
operating in one of a first mode and a second mode for determining a graphical display element layout.

2. The method of claim 1 wherein operating in the first mode comprises:
displaying a first plurality of functional design elements corresponding to a plurality of design functions;
receiving a first mode input;
modifying a characteristic of the grid responsive to the first mode input;
automatically modifying the object on the grid based on modifying the characteristic of the grid.

3. The method of claim 2 wherein modifying the characteristic of the grid includes resizing the grid responsive to the first mode input.

4. The method of claim 3 wherein the object has associated design properties, and wherein automatically modifying the object on the grid includes resizing the object substantially proportional to resizing the grid and maintaining the design properties of the object.

5. The method of claim 3 further comprising determining a margin, the margin corresponding to a distance between an aspect of the object and a corresponding aspect of the grid.

6. The method of claim 5 wherein automatically modifying the object on the grid includes resizing the object and maintaining the margin between the aspect of the object and the corresponding aspect of the grid.

7. The method of claim 2 further comprising receiving an input selection of at least one of the displayed functional design elements and executing a design function from the plurality of design functions corresponding to the selected at least one of the displayed functional design elements.

8. The method of claim 7 wherein executing the design function includes modifying a characteristic of the object responsive to the input selection.

9. The method of claim 1 wherein operating in the second mode includes:
displaying a second plurality of functional design elements;
receiving a second mode input;
modifying a characteristic of the grid responsive to the second mode input;
maintaining the object on the grid.

10. The method of claim 9 wherein modifying the characteristic of the grid includes resizing the grid responsive to the second mode input.

11. The method of claim 10 wherein the object has design properties and wherein maintaining the object on the grid comprises maintaining dimensions of the object while resizing the grid while modifying the design properties of the object based on modifying the characteristic of the grid.

12. The method of claim 9 wherein displaying the second plurality of functional design elements comprises displaying fewer functional design elements than the first plurality of functional design elements.

13. The method of claim 12 wherein the second plurality of functional design elements includes a subset of the first plurality of functional design elements.

14. The method of claim 12 wherein each of the functional design elements in the first plurality of functional design elements are different from each of the functional design elements in the second plurality of functional design elements.

15. The method of claim 12 wherein displaying the subset of the second plurality of functional design elements includes not displaying any of the functional design elements in the first plurality.

16. The method of claim 2 wherein operating in the second mode includes:
receiving a second mode input;
modifying a characteristic of the grid responsive to the second mode input;
modifying the object on the grid independently of modifying the characteristic of the grid.

17. The method of claim 16 wherein none of the first plurality of functional design elements is displayed in the second mode.

18. The method of claim 1 further comprising;
receiving a selection via the first display element;
switching an operation mode responsive to the received selection via the first display element.

19. The method of claim 18 wherein switching the operation mode includes switching between the first mode and the second mode.

20. A computer-readable medium having executable code for performing the following steps:
defining a grid;
positioning an object on the grid;
displaying a first display element for changing operation between at least a first mode and a second mode;
receiving a selection via the first display element;
switching an operation mode responsive to the received selection via the first display element;
operating in one of a first mode and a second mode for determining a graphical display element layout,
wherein operating in the first mode comprises:
displaying a first plurality of functional design elements corresponding to a plurality of design functions;
receiving a first mode input;
modifying a characteristic of the grid responsive to the first mode input;
automatically modifying the object on the grid based on modifying the characteristic of the grid and
operating in the second mode includes:
displaying a second plurality of functional design elements;
receiving a second mode input;
modifying a characteristic of the grid responsive to the second mode input;
maintaining the object on the grid.
